(19) United States
(12) Patent Application Publication
(10) Pub. No.: US 2026/0037591 A1
(43) Pub. Date: Feb. 5, 2026

(54) DATA PROCESSING DEVICE, DATA PROCESSING METHOD, AND DATA PROCESSING PROGRAM

(71) Applicant: NTT, Inc., Tokyo (JP)

(72) Inventors: Daisuke KOBAYASHI, Tokyo (JP); Saki HATTA, Tokyo (JP); Ken NAKAMURA, Tokyo (JP); Yuya OMORI, Tokyo (JP); Hiroyuki UZAWA, Tokyo (JP); Yuko IINUMA, Tokyo (JP); Shuhei YOSHIDA, Tokyo (JP)

(73) Assignee: NTT, Inc., Tokyo (JP)

(21) Appl. No.: 18/878,366

(22) PCT Filed: Jul. 4, 2022
(86) PCT No.: PCT/JP2022/026640

§ 371 Date: Dec. 23, 2024

(51) Int. Cl. G06F 17/11

(52) U.S. Cl. CPC G06F 17/11

(57) ABSTRACT

A data processing device includes a processing unit. A processing unit selects an input value included in an input domain of a processing LUT from among a plurality of the input values that are values of inputs, selects only an approximation coefficient of a piece necessary for an operation from a total coefficient storage unit, stores the selected approximation coefficient in the processing LUT, outputs an approximation coefficient corresponding to the selected input value from the processing LUT, and performs polynomial approximation operation by using the selected input value and the output approximation coefficient.

### TECHNICAL FIELD

The disclosed technology relates to a data processing device, a data processing method, and a data processing program.

### BACKGROUND ART

In a neural network in artificial intelligence (AI)/machine learning, a final output value is determined by applying a specific function to the sum of values obtained by adding a bias value to a value obtained by multiplying respective inputs to a certain neuron by a weight. This specific function is referred to as an activation function. The activation function varies depending on the neural network model to be used, and representative examples thereof include a ReLU function, a sigmoid function, and a tanh function, and with the appearance of a new neural network model, a new activation function has also appeared.

Furthermore, in recent years, edge AI processing in which AI inference processing is executed not on a cloud or an on-premises server but on an edge terminal such as a drone or a monitoring camera has attracted attention. In the edge AI processing, it is desirable to perform inference processing on hardware such as an application specific integrated circuit (ASIC) from the viewpoint of power consumption and processing speed. However, since it is difficult to perform correction and additional extension once circuit information is written in the ASIC, there is a problem that only an activation function determined at the time of design can be operated and future extension is difficult. Furthermore, since the activation functions are configured using not only a simple linear operation but also a nonlinear function such as an exp function and a sin function, sufficient circuits for the function processing cause an increase in circuit scale.

As a method of performing a plurality of types of activation function processing with low resources, there is a look-up table (LUT) method in which a pair of input and output of an activation function are held as a table and used for processing (See, for example, Non Patent Literature 1). In the LUT method, since an output with respect to an input to the activation function can be calculated in advance, function operation processing inside hardware is unnecessary, and it is also possible to cope with a plurality of types of function processing by changing a value to be written in a table.

Furthermore, similarly, as a method of performing a plurality of types of activation function processing with low resources, there is a method of performing piecewise polynomial approximation on the activation function. The piecewise polynomial approximation is a method in which a domain of an input is divided at equal intervals or non-equal intervals for a certain function, and then the polynomial approximation is performed on each piece.

In the polynomial approximation, an arbitrary function is approximated with the following polynomial, and the value of a coefficient aₖ is different for each piece.

$$f ( x ) = {a}_{0} + {a}_{1} {x}^{1} + {a}_{2} {x}^{2} + … + {a}_{k - 1} {x}^{k - 1}$$

### CITATION LIST

### Non Patent Literature

Non Patent Literature 1: Shinobu NAGAYAMA, Tsutomu SASAO, and Jon T. BUTLER, “Numerical Function Generators Based on Polynomial Approximation Suitable for FPGA Implementation”, Institute of Electronics, Information and Communication Engineers (IEICE), Technical Report.

### SUMMARY OF INVENTION

### Technical Problem

In the method using the LUT in the related art, it is necessary to read a pair of input and output in the table, and thus the table size increases according to bitwise operation accuracy. For example, there are 2⁸=256 inputs in the 8-bit operation, but there are 216=65536 inputs in the 16-bit operation, and the table size increases in order to correspond to 16 bits. Furthermore, the wiring between the table and a selector portion for selecting an output value to be actually used becomes more complicated, which leads to an increase in circuit scale.

A method of reducing the number of table stages of the LUT to the number of pieces by storing a coefficient aₖ used in the piecewise polynomial approximation in the LUT is also conceivable. However, as the number of pieces is smaller, the table size of the LUT and the complexity of the wiring are reduced, but the approximation accuracy decreases, and there is a problem that the original purpose of the operation is not achieved. Conversely, when the number of pieces is increased, the approximation accuracy increases, but the table size of the LUT and the complexity of the wiring increase, which leads to an increase in circuit scale.

Therefore, it is required to perform circuit design after appropriately considering the number of pieces. However, there is a possibility that necessary approximation accuracy cannot be obtained for an activation function to appear in the future with a predetermined number of pieces since it can be easily imagined that a new activation function appears in the future.

The disclosed technology has been made in view of the above-described points, and an object thereof is to provide a data processing device, a data processing method, and a data processing program, in which processing suitable for necessary accuracy and throughput can be performed while suppressing an increase in circuit scale in a case where polynomial approximation for each piece of an activation function is implemented by an LUT.

### Solution to Problem

According to a first aspect of the present disclosure, there is provided a data processing device including: a processing unit that processes an n-th order polynomial with polynomial approximation for each piece with respect to an input; a look-up table configured to hold an approximation coefficient used for a polynomial approximation operation; and a total coefficient storage unit that stores approximation coefficients of all pieces when the polynomial approximation is performed, the number of approximation coefficients being larger than the number of table stages of the look-up table, in which the processing unit includes an input value selection unit that selects an input value included in an input domain of the look-up table from among a plurality of the input values that are values of the inputs, a piece selector that selects only the approximation coefficient of a piece necessary for the operation from the total coefficient storage unit, a processing coefficient storage unit that stores the approximation coefficient selected by the piece selector in the look-up table, and outputs, from the look-up table, the approximation coefficient corresponding to the input value selected by the input value selection unit, and an operation unit that performs the polynomial approximation operation by using the input value selected by the input value selection unit and the approximation coefficient output by the processing coefficient storage unit.

According to a second aspect of the present disclosure, there is provided a data processing method performed by a data processing device including a processing unit that processes an n-th order polynomial with polynomial approximation for each piece with respect to an input, a look-up table configured to hold an approximation coefficient used for a polynomial approximation operation, and a total coefficient storage unit that stores approximation coefficients of all pieces when the polynomial approximation is performed, the number of approximation coefficients being larger than the number of table stages of the look-up table, the data processing method including: by the processing unit, selecting an input value included in an input domain of the look-up table from among a plurality of the input values that are values of the inputs; selecting only the approximation coefficient of a piece necessary for the operation from the total coefficient storage unit; storing the selected approximation coefficient in the look-up table; outputting, from the look-up table, the approximation coefficient corresponding to the selected input value; and performing the polynomial approximation operation by using the selected input value and the output approximation coefficient.

According to a third aspect of the present disclosure, there is provided a data processing program of a data processing device including a processing unit that processes an n-th order polynomial with polynomial approximation for each piece with respect to an input, a look-up table configured to hold an approximation coefficient used for a polynomial approximation operation, and a total coefficient storage unit that stores approximation coefficients of all pieces when the polynomial approximation is performed, the number of approximation coefficients being larger than the number of table stages of the look-up table, the data processing program causing a computer to execute processing of: by the processing unit, selecting an input value included in an input domain of the look-up table from among a plurality of the input values that are values of the inputs; selecting only the approximation coefficient of a piece necessary for the operation from the total coefficient storage unit; storing the selected approximation coefficient in the look-up table; outputting, from the look-up table, the approximation coefficient corresponding to the selected input value; and performing the polynomial approximation operation by using the selected input value and the output approximation coefficient.

### Advantageous Effects of Invention

According to the disclosed technology, in a case where the polynomial approximation for each piece of the activation function is implemented by the LUT, there is an effect that the processing suitable for necessary accuracy and throughput can be performed while suppressing an increase in circuit scale.

Furthermore, the processing corresponding to a larger number of pieces can be performed by suppressing an increase in the number of pieces in circuit implementation, and the processing with a reduced update delay of the LUT can be performed by suppressing the update frequency of the LUT.

### BRIEF DESCRIPTION OF DRAWINGS

FIG. 1 is a block diagram illustrating an example of a circuit configuration of a data processing device according to a first embodiment.

FIG. 2 is a diagram illustrating an example of approximation coefficients of all pieces stored in a total coefficient storage unit according to the embodiment.

FIG. 3 is a flowchart illustrating an example of a flow of processing by a data processing device according to the first embodiment.

FIG. 4 is a diagram illustrating an example of input data according to a second embodiment.

FIG. 5 is a flowchart illustrating an example of a flow of processing by a data processing device according to the second embodiment.

FIG. 6 is a diagram in which a tile index t, a block index i, an LUT piece index n, a parameter α, and a timing when updating of a processing LUT is necessary are organized at a time of executing step S116 of FIG. 5.

FIG. 7 is a diagram illustrating a case where an LUT is updated from an LUT piece 0 every time a tile changes without using a parameter α according to a comparative example.

FIG. 8 is a diagram illustrating a case where an LUT is updated while sequentially updating LUT pieces for each block according to a comparative example.

FIG. 9 is a diagram illustrating a part of a layer structure of a series of neural networks with activation function processing.

FIG. 10 is a diagram illustrating an example of a modified network structure.

### DESCRIPTION OF EMBODIMENTS

Hereinafter, examples of an embodiment of the disclosed technology will be described with reference to the drawings. Note that in the drawings, the same or equivalent components and portions will be denoted by the same reference signs. Furthermore, dimensional ratios in the drawings are exaggerated for convenience of description and thus may be different from actual ratios.

A data processing device according to the present embodiment provides a specific improvement over a related-art method of performing activation function processing using an LUT, and indicates improvement in a technical field related to the activation function processing when inference processing by a neural network is implemented on hardware. In the present embodiment, when a plurality of types of activation function processing are performed, an approximation coefficient of a polynomial for each piece, which can be used according to purposes of accuracy and throughput, is stored in the LUT, and the activation function processing is performed.

Specifically, at the time of polynomial approximation, the number of pieces (N_t) that is truly necessary and the number of pieces (N_i) in the circuit implementation are introduced, and N_i coefficients loaded on the LUT are updated (N_t/N_i) times to cover all inputs. Moreover, the inference processing is configured to be capable of hiding the update processing time of the LUT in the activation function processing on hardware that divides an image/feature map into a plurality of blocks/tiles and performs processing. Specifically, instead of applying the LUT processing of a piece n and a piece n+1, . . . for each block, a plurality of blocks are applied first to the input included in the piece n, and when all the inputs included in the piece n are completed, the approximation coefficient of the LUT is rewritten for the piece n+1, and then the LUT processing is performed again on the input included in the piece n+1 for the same input block.

### First Embodiment

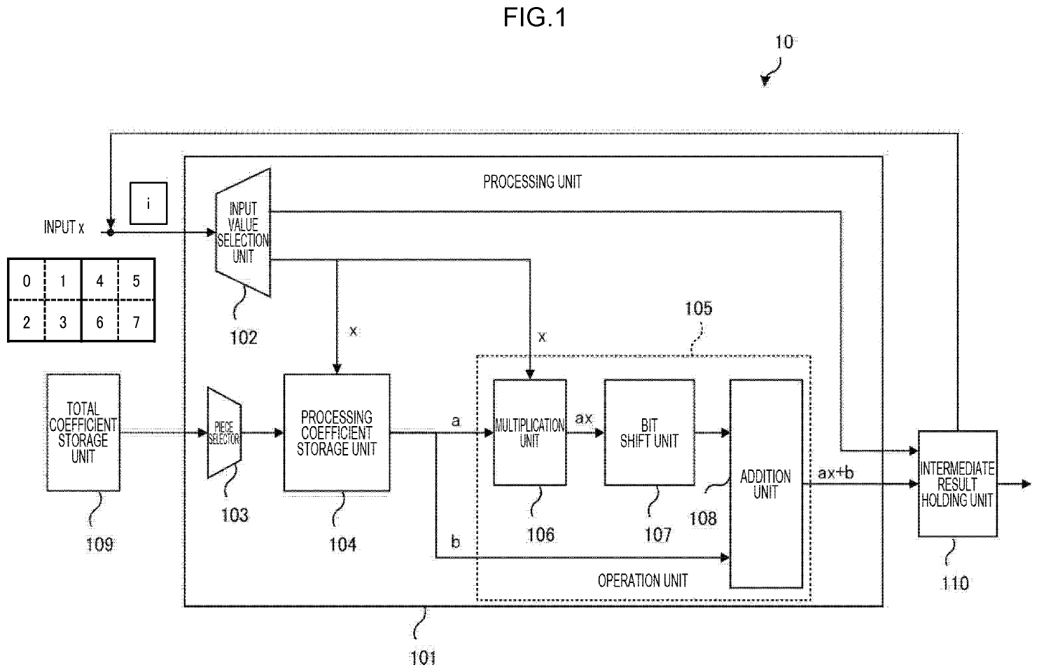

FIG. 1 is a block diagram illustrating an example of a circuit configuration of a data processing device 10 according to a first embodiment.

Note that an example illustrated in FIG. 1 indicates a case where each piece is approximated by a first-order polynomial. However, in the present embodiment, since the main purpose is to extend the number of pieces in the LUT, the degree in polynomial approximation is not limited to only the first-order degree, and may also be applicable to the second-order degree and the third-order degree.

As illustrated in FIG. 1, the data processing device 10 includes, as a circuit configuration, a processing unit 101, a total coefficient storage unit 109, and an intermediate result holding unit 110. The processing unit 101 includes an input value selection unit 102, a piece selector 103, a processing coefficient storage unit 104, and an operation unit 105. The operation unit 105 includes a multiplication unit 106, a bit shift unit 107, and an addition unit 108.

The processing unit 101 processes the n-th order polynomial for each piece with polynomial approximation with respect to the input. The processing unit 101 holds the approximation coefficient used for the polynomial approximation operation in the LUT, and performs an operation by referring an appropriate approximation coefficient for an input value from the LUT.

For example, the processing unit 101 is configured as a processor having a circuit configuration specifically designed to execute specific processing of a programmable logic device (PLD), ASIC, or the like of which the circuit configuration can be changed after manufacturing, such as a field-programmable gate array (FPGA).

Furthermore, the processing coefficient storage unit 104, the total coefficient storage unit 109, and the intermediate result holding unit 110 are configured as a part of a memory such as a read only memory (ROM) or a random access memory (RAM).

The processing coefficient storage unit 104 stores a LUT (hereinafter, referred to as a “processing LUT”) for holding approximation coefficients used for a polynomial approximation operation. The total coefficient storage unit 109 stores the approximation coefficients of all the pieces at the time of performing the polynomial approximation, the number of approximation coefficients being larger than the number of table stages of the processing LUT.

The input value selection unit 102 selects an input value included in an input domain (that is, piece) of the processing LUT from among a plurality of input values that are input values. In the example of FIG. 1, an input x is represented as a block of eight pixels of 2×4.

The piece selector 103 selects only the approximation coefficient of the piece necessary for an operation from the total coefficient storage unit 109. That is, the piece selector 103 selects the piece for the approximation coefficient to be stored when the approximation coefficient necessary for the operation from the total coefficient storage unit 109 is stored in the processing LUT.

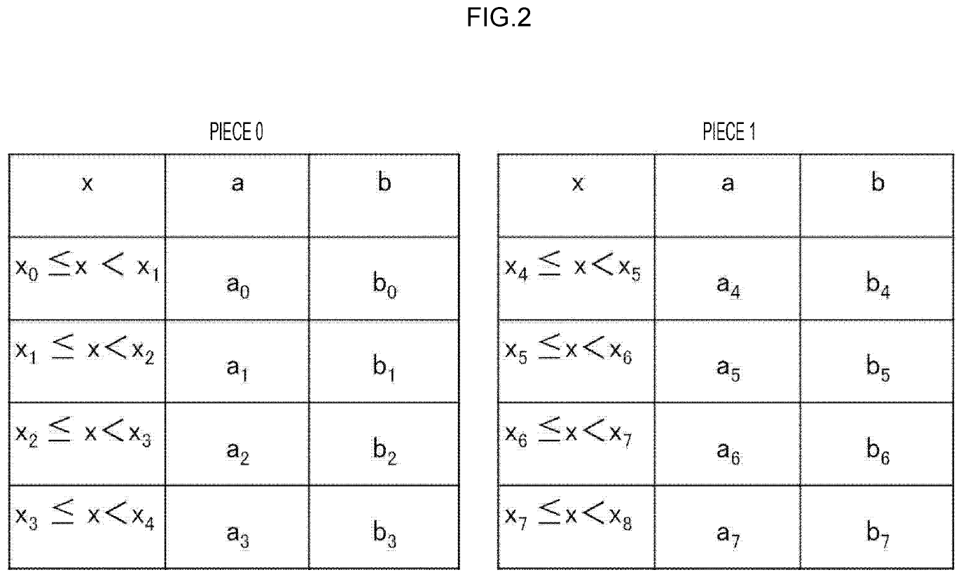

FIG. 2 is a diagram illustrating an example of the approximation coefficients of all pieces stored in the total coefficient storage unit 109 according to the present embodiment.

As illustrated in FIG. 2, the total coefficient storage unit 109 stores approximation coefficients corresponding to the total number of pieces that are truly necessary, as a LUT divided for each number of pieces in implementation (that is, the number of pieces of the processing LUT). The example of FIG. 2 illustrates a case where the number of all pieces truly necessary is eight and the number of pieces in implementation is four. However, the total number of pieces truly necessary and the number of pieces in implementation are not limited in value except that there is a relationship of the total number of pieces truly necessary>the number of pieces in implementation.

Specifically, the total coefficient storage unit 109 stores the approximation coefficients of all the pieces in units of the number of table stages of the processing LUT, and stores the approximation coefficients of all the pieces by assigning an index to each piece of all the pieces.

The processing coefficient storage unit 104 stores the approximation coefficient selected by the piece selector 103 in the processing LUT, and outputs the approximation coefficient corresponding to the input value selected by the input value selection unit 102 from the processing LUT. In the example of FIG. 1, the processing LUT is referred to for the input x, and the corresponding approximation coefficients a and b are output from the processing LUT.

The operation unit 105 performs the polynomial approximation operation by using the input value selected by the input value selection unit 102 and the approximation coefficient output by the processing coefficient storage unit 104. As described above, the operation unit 105 includes the multiplication unit 106, the bit shift unit 107, and the addition unit 108. The multiplication unit 106 multiplies the input x by the approximation coefficient a from the processing LUT and outputs ax. The bit shift unit 107 shifts the bit string of ax output from the multiplication unit 106 rightward or leftward by the specified number. The addition unit 108 adds ax output from the bit shift unit 107 and the approximation coefficient b from the processing LUT to obtain ax+b, and outputs ax+b to the intermediate result holding unit 110 and holds the result in the intermediate result holding unit 110.

Here, the intermediate result holding unit 110 holds an unprocessed input value that is not included in the input domain (piece) of the processing LUT as an intermediate result obtained by the polynomial approximation operation. The input value selection unit 102 receives the unprocessed input value held by the intermediate result holding unit 110 as an input again.

The processing unit 101 performs a polynomial approximation operation on an input value included in the input domain (piece) of the processing LUT, performs processing of holding the operation result in the intermediate result holding unit 110, performs processing of skipping the polynomial approximation operation on an unprocessed input value not included in the input domain (piece) of the processing LUT and holding the unprocessed input value in the intermediate result holding unit 110, and updates the processing LUT with the approximation coefficient of another piece stored in the total coefficient storage unit 109 in a case where any processing is performed on all input values. Then, the processing unit 101 performs a polynomial approximation operation in a case where an unprocessed input value is included in the input domain (piece) of the updated processing LUT, performs processing of holding the operation result in the intermediate result holding unit 110, performs processing of skipping the polynomial approximation operation in a case where the unprocessed input value is not included in the input domain (piece) of the updated processing LUT and holding the unprocessed input value in the intermediate result holding unit 110, and repeats the similar processing until the approximation coefficients of all the pieces stored in the total coefficient storage unit 109 are referred to. Then, the processing unit 101 finally outputs the operation result held in the intermediate result holding unit 110 when the polynomial approximation operation on all the input values is completed.

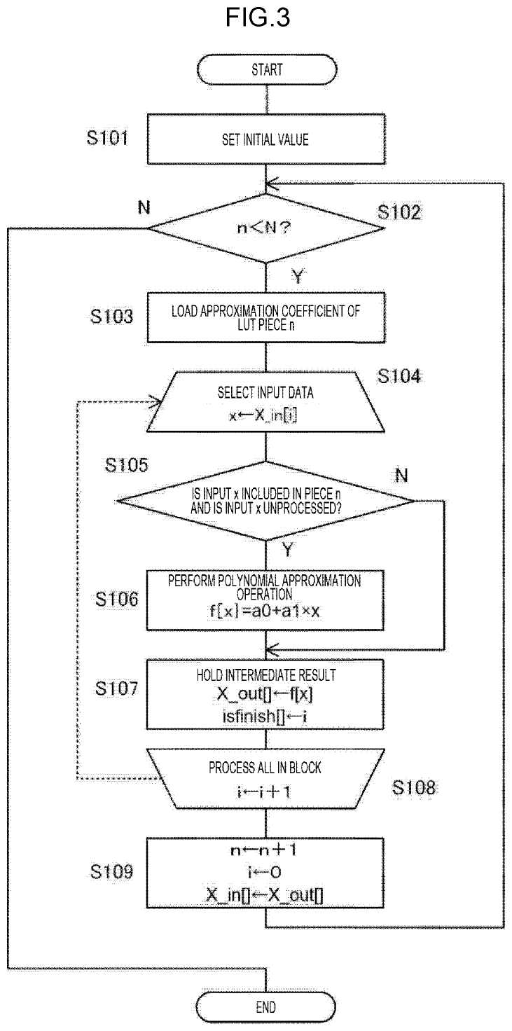

Next, an operation of the data processing device 10 according to the first embodiment will be described with reference to FIG. 3.

FIG. 3 is a flowchart illustrating an example of a flow of processing by the data processing device 10 according to the first embodiment.

In step S101 of FIG. 3, the processing unit 101 sets an initial value necessary for data processing. A variable n (initial value=zero) represents an LUT piece index, and a value obtained by dividing the number of pieces N_t truly necessary by the number of pieces N_i in implementation is set as N (=N_t/N_i). Note that in this example, N=2. At this time, the variable n is used as an index that changes one by one between 0 (zero) and (N−1). A variable X_in [i] represents an input block, and a variable X_out [i] represents an output block and an intermediate result holding block. i represents a block index.

In step S102, the processing unit 101 determines whether or not the LUT piece index n is smaller than N (=2). In a case where it is determined that the LUT piece index n is smaller than N (in the case of positive determination), the processing proceeds to step S103, and in a case where it is determined that the LUT piece index n is equal to or larger than N (in the case of negative determination), this data processing ends. Specifically, when n=0, n (=0)<N (=2) is satisfied, and thus the processing proceeds to step S103.

In step S103, the processing unit 101 loads and stores the approximation coefficient of the LUT piece index n from the total coefficient storage unit 109 in the processing LUT. Specifically, when n=0, the approximation coefficients a and b of a piece 0 illustrated in FIG. 2 described above are loaded and stored in the processing LUT.

In step S104, the processing unit 101 selects an input x as an input value to be processed from an input block X_in [i] as the input value selection processing.

In step S105, the processing unit 101 determines whether or not the input x is included in the input domain of the LUT piece index n and the input x is unprocessed. Specifically, in the example of FIG. 2 described above, it is determined whether or not the input x is included in x₀≤x<x₄, which is the input domain of a piece 0, and the input x is unprocessed. In a case where it is determined that the input x is included in the input domain of the LUT piece index n and the input x is unprocessed (in the case of positive determination), the processing proceeds to step S106, and in a case where it is determined that the input x is not included in the input domain of the LUT piece index n, that is, the input x is x₄≤x, or the input x is not unprocessed (in the case of negative determination), step S106 is skipped, and the processing proceeds to step S107.

In step S106, the processing unit 101 specifies the approximation coefficients a and b according to the input x from the processing LUT, and performs a polynomial approximation operation (approximation function operation) by using the input x and the specified approximation coefficients a and b.

In step S107, the processing unit 101 holds the operation result obtained by the operation in step S106 in the intermediate result holding unit 110, and holds the unprocessed input x in the intermediate result holding unit 110 in step S105.

In step S108, the processing unit 101 determines whether or not all the input values in the input block X_in [i] have been processed. In a case where the processing has not been performed on all the input values, the block index i is incremented by one (i←i+1), and the processing returns to step S104 and the processing is repeated for the input block X_in [i] corresponding to the incremented block index i. That is, similarly, the processing from step S104 to step S108 are repeated for all the input values in the input block. On the other hand, in a case where the processing has been performed on all the input values, the processing proceeds to step S109.

In step S109, in a case where the processing from step S104 to step S108 are completed for all the input values in the input block, the processing unit 101 increments the LUT piece index n by one (n←n+1), initializes the block index i to zero (i←0), overwrites the input block X_in [ ] with the intermediate result holding block X_out [ ], and then returns to the processing of step S102.

Next, in step S102, for the LUT piece index n (=1), the processing unit 101 determines whether or not the LUT piece index n is smaller than N. Here, n (=1)<N (=2), and thus the processing proceeds to step S103.

In step S103, the processing unit 101 loads and stores the approximation coefficient of the LUT piece index n from the total coefficient storage unit 109 in the processing LUT. Specifically, when n=1, the approximation coefficients a and b of a piece 1 illustrated in FIG. 2 described above are loaded and stored in the processing LUT.

In step S104, the processing unit 101 selects an input x as an input value to be processed from an input block X_in [i] as the input value selection processing.

In step S105, the processing unit 101 determines whether or not the input x is included in the input domain of the LUT piece index n and the input x is unprocessed. Specifically, in the example of FIG. 2 described above, it is determined whether or not the input x is included in x₄≤x<x₈, which is the input domain of the piece 1 and the input x is unprocessed. In a case where it is determined that the input x is included in the input domain of the LUT piece index n and the input x is unprocessed (in the case of positive determination), the processing proceeds to step S106, and in a case where it is determined that the input x is not included in the input domain of the LUT piece index n, for example, the input x is x₈≤x, or the input x is not unprocessed (in the case of negative determination), step S106 is skipped, and the processing proceeds to step S107.

In step S106, the processing unit 101 specifies the approximation coefficients a and b according to the input x from the processing LUT, and performs a polynomial approximation operation (approximation function operation) by using the input x and the specified approximation coefficients a and b.

In step S107, the processing unit 101 holds the operation result obtained by the operation in step S106 in the intermediate result holding unit 110, and holds the unprocessed input x in the intermediate result holding unit 110 in step S105.

In step S108, the processing unit 101 determines whether or not all the input values in the input block X_in [i] have been processed. In a case where the processing has not been performed on all the input values, the block index i is incremented by one (i←i+1), and the processing returns to step S104 and the processing is repeated for the input block X_in [i] corresponding to the incremented block index i. That is, similarly, the processing from step S104 to step S108 are repeated for all the input values in the input block. On the other hand, in a case where the processing has been performed on all the input values, the processing proceeds to step S109.

In step S109, in a case where the processing from step S104 to step S108 are completed for all the input values in the input block, the processing unit 101 increments the LUT piece index n by one (n←n+1), initializes the block index i to zero (i←0), overwrites the input block X_in [ ] with the intermediate result holding block X_out [ ], and then returns to the processing of step S102.

Next, in step S102, for the LUT piece index n (=2), the processing unit 101 determines whether or not the LUT piece index n is smaller than N. Here, n (=2)=N (=2), and thus a series of processing end.

Through the above-described processing, the approximation operation is performed with any one of the approximation coefficients included in the LUT piece index n=0 or 1 for all the original input data, and even in a case where the number of pieces in the implementation is small than the true number of pieces, the approximation operation can be performed with accuracy with a value equivalent to the true number of pieces.

### Second Embodiment

Next, a second embodiment will be described. The data processing device according to the second embodiment has a circuit configuration similar to the circuit configuration illustrated in FIG. 1 described above, but processing in the case of input data in which a plurality of blocks is provided as one block will be described.

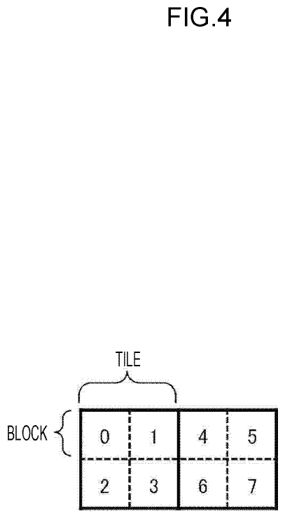

FIG. 4 is a diagram illustrating an example of input data according to the second embodiment.

As illustrated in FIG. 4, the input data is supplied in units of a tile including a plurality of blocks each including a plurality of input values. Specifically, blocks 0, 1, 2, and 3 in FIG. 4 are set as a tile 1, blocks 4, 5, 6, and 7 are set as a tile 2, and the input data is supplied in units of tiles.

As an example, in a case where the input value of each block in a first tile (for example, tile 1) is processed for the input data illustrated in FIG. 4, the processing unit 101 according to the present embodiment (see FIG. 1 described above) updates the processing LUT with the approximation coefficient of another piece stored in the total coefficient storage unit 109. Then, the processing unit 101 does not update the updated processing LUT in a case where the processing proceeds from the first tile to a second tile (for example, tile 2) which is the next tile, and updates the processing LUT updated in an order opposite to the first tile in a case where the input value of each block in the second tile is processed. Then, the processing unit 101 does not update the processing LUT updated in an order opposite to the first tile in a case where the processing proceeds from the second tile to a third tile (not illustrated) which is the next tile, and updates the processing LUT updated in an order opposite to the first tile in an order opposite to the second tile in a case where the input value of each block in the third tile is processed.

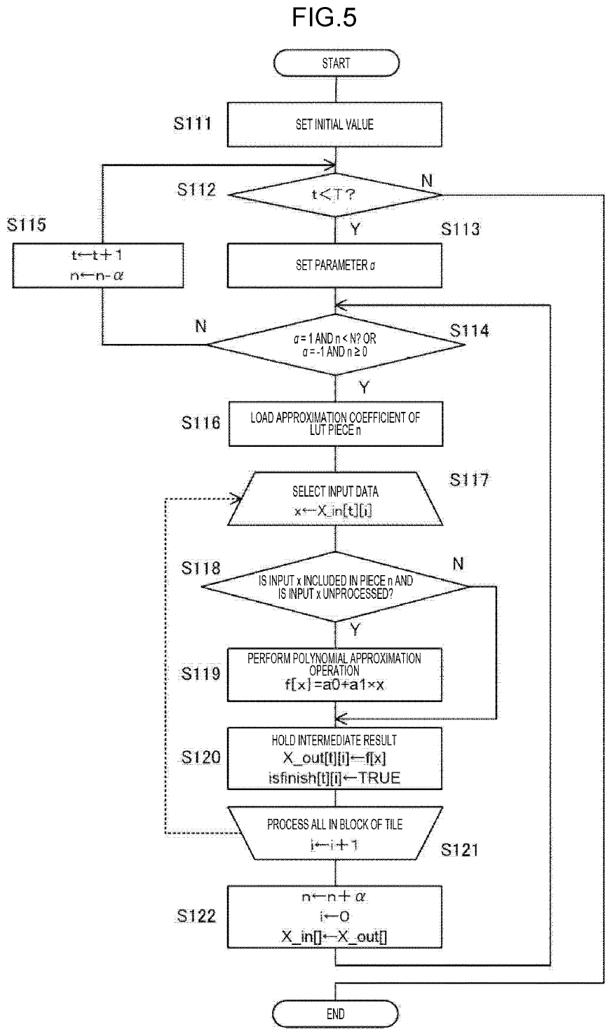

Next, an operation of the data processing device 10 according to the second embodiment will be described with reference to FIG. 5.

FIG. 5 is a flowchart illustrating an example of a flow of processing by the data processing device 10 according to the second embodiment. Note that, since the flowchart illustrated in FIG. 5 includes processing similar to some processing of the flowchart illustrated in FIG. 3 described above, a different part will be mainly described.

First, in step S111 of FIG. 5, the processing unit 101 sets an initial value necessary for data processing. As an example, an input tile block X_in [t][i] is prepared for the input data illustrated in FIG. 4 described above. Here, t (initial value=0) represents a tile index, i represents a block index in one tile, and input data is exchanged in units of tiles and blocks. Furthermore, n (initial value=0) represents an LUT piece index, and T represents the total number of tiles (T=2 in this example). X_out [t][i] is prepared for holding an intermediate result so as to form a pair with the input tile block X_in [t][i]. X_out [t][i] represents an output tile block and an intermediate result holding tile block.

In step S112, the processing unit 101 determines whether or not the tile index t is smaller than the total number of tiles T, that is, whether or not the processing has been completed for all the tiles. In a case where it is determined that there is an unprocessed tile (in the case of positive determination), the processing proceeds to step S113, and in a case where it is determined that there is not the unprocessed tile (in the case of negative determination), a series of the processing end.

In step S113, the processing unit 101 sets a parameter α on the basis of the tile index t. Specifically, α=1 is set when the tile index t is zero or an even number, and α=−1 is set when the tile index t is an odd number.

In step S114, the processing unit 101 determines whether or not “α=1 and n<N” is satisfied or whether or not “α=−1 and n≥0” is satisfied. Here, in a case where it is determined that “α=1 and n<N” is not satisfied or in a case where it is determined that “α=−1 and n≥0” is not satisfied (in the case of negative determination), the processing proceeds to step S115, and in a case where it is determined that “α=1 and n<N” is satisfied or in a case where it is determined that “α=−1 and n≥0” is satisfied (in the case of positive determination), the processing proceeds to step S116.

In step S115, the processing unit 101 increments the tile index t by one (t←t+1), sets the LUT piece index n to n←n−α, and returns to step S112 to repeat the processing. On the other hand, in a case where the processing proceeds to step S116, the processing from step S116 to step S121 are performed, but since these processing are similar to the processing from step S103 to step S108 in FIG. 3 described above, the repeated description thereof will be omitted.

In step S122, in a case where the processing from step S117 to step S121 are completed for all the input values in the input block of the tile, the processing unit 101 sets the LUT piece index n to n←n+α, initializes the block index i to zero (i←0), overwrites the input tile block X_in [ ] with the intermediate result holding tile block X_out [ ], and then returns to the processing of step S114.

Specifically, in a case where the processing has been completed for all the input values of the input block in the tile, in step S122, the value of the LUT piece index n is updated to 0→1. That is, in a case where the tile index t=0, α=1 is satisfied, and thus the value of the LUT piece index n is updated to 1←0+1. As a result of the update, since “α=1 and n (=1)<N (=2)” is satisfied in step S114, the positive determination is made, and the processing proceeds to step S116. Hereinafter, the similar processing are executed from step S116 to step S121.

Next, in step S122, the value of the LUT piece index n is updated to 1→2. That is, in a case where the tile index t=0, α=1 is satisfied, and thus the value of the LUT piece index n is updated to 2←1+1. As a result of the update, since “α=1 and n (=2)=N (=2)” is satisfied in step S114, the negative determination is made, and the processing proceeds to step S115.

In step S115, the value of the tile index t (t=0) is updated to t=0+1=1, the value of the LUT piece index n (n=2) is updated to n=2−1=1, and the processing proceeds to step S112. However, α=1 is satisfied.

Next, in step S112, in a case where there is an unprocessed tile (in the case of positive determination), the processing proceeds to step S113, and in step S113, the value of α is updated to 1→−1 according to the update of the tile index t (0→1). As a result of the update, since “α=−1 and n (=1)≥0” is satisfied in step S114, the positive determination is made, and the processing proceeds to step S116. Hereinafter, the similar processing are executed from step S116 to step S121.

Next, in step S122, in a case where the processing of the LUT piece indexes n=1 and n=0 is completed for all the blocks in the tile index t=1, n=0−1=−1 is set, and the processing returns to step S114. However, α=−1 is satisfied.

Since “a =-1 and n (=-1) <0” is satisfied in step S114, the negative determination is made, and the processing proceeds to step S115.

In step S115, the value of the tile index t (t=1) is updated to t=1+1=2, the value of the LUT piece index n (n=−1) is updated to n=−1−(−1)=0, and the processing proceeds to step S112.

In step S112, since the value of the tile index t (t=2) is the total number of tiles T (=2), that is, t=T, the negative determination is made, and a series of processing end.

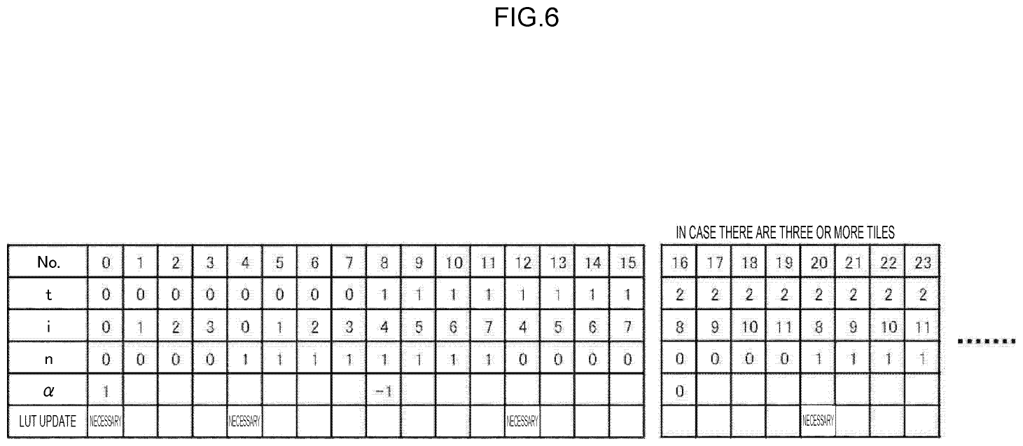

Next, the timing of updating the processing LUT at the time of executing step S116 will be described with reference to FIGS. 6 to 8.

FIG. 6 is a diagram in which the tile index t, the block index i, the LUT piece index n, the parameter α, and a timing when updating of a processing LUT is necessary are organized at a time of executing step S116 of FIG. 5.

As illustrated in FIG. 6, in the present embodiment, when the tile is updated while the processing is switched in the order of an LUT piece→a block→a tile, the LUT piece is not updated, and then the LUT piece is updated in the reverse order with the effect of the parameter α.

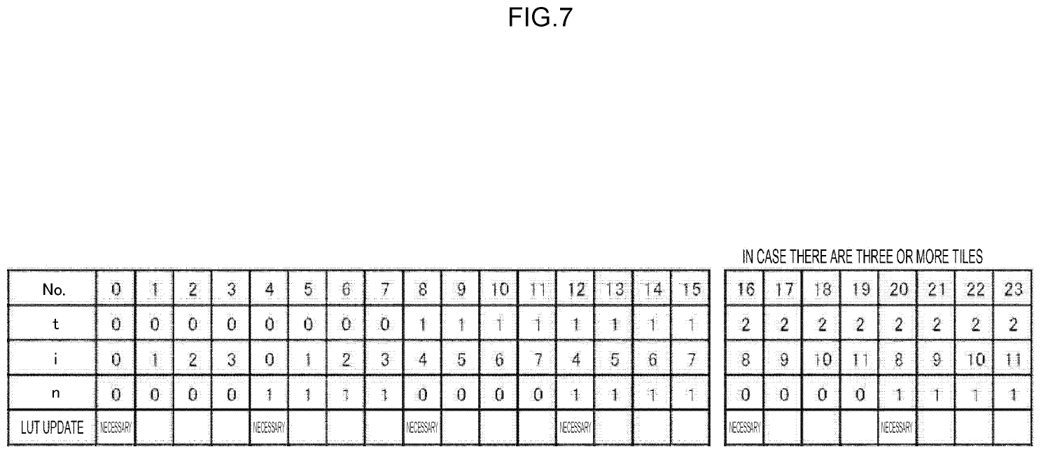

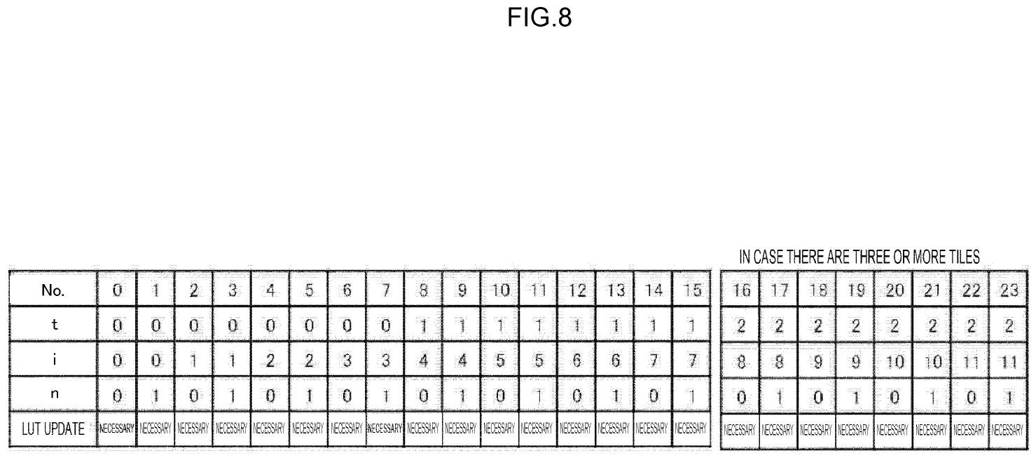

FIG. 7 is a diagram illustrating a case where the LUT is updated from an LUT piece O every time a tile changes without using the parameter α according to a comparative example. FIG. 8 is a diagram illustrating a case where the LUT is updated while sequentially updating LUT pieces for each block according to a comparative example.

In the example of the present embodiment illustrated in FIG. 6, less LUT update processing is implemented as compared with the comparative example to be illustrated in FIG. 7 in which the LUT is updated from the LUT piece 0 every time a tile changes without using the parameter α, or the comparative example to be illustrated in FIG. 8 in which the LUT is updated while sequentially updating the LUT piece for each block. Therefore, it is possible to perform an approximation operation using an approximation coefficient corresponding to the true number of pieces for input values in all tiles and all blocks while suppressing a delay of update processing caused by unnecessary LUT update processing.

### Third Embodiment

Next, a third embodiment will be described. In the first embodiment and the second embodiment, the method of realizing the true number of pieces under the restriction of the number of pieces in implementation has been described focusing on the processing in the activation function processing. On the other hand, in the third embodiment, a method of implementing equivalent processing by changing the structure of the neural network will be described.

In the activation function (Activation) processing of the neural network, the processing unit 101 according to the present embodiment (see FIG. 1 described above) generates an activation function processing layer (Activation layer) as a sublayer by the number obtained by dividing the piece truly necessary for the polynomial approximation operation by the number of pieces of the processing LUT implemented in the activation function processing circuit. In each sublayer, the processing unit 101 performs activation function processing on an input value included in the input domain of the processing LUT of the divided piece, performs processing of outputting 0 (zero) to an input value not included in the input domain of the processing LUT, and performs activation function processing by polynomial approximation corresponding to the true number of pieces by integrating the output results of a plurality of the sublayers generated last by an addition layer (Add layer).

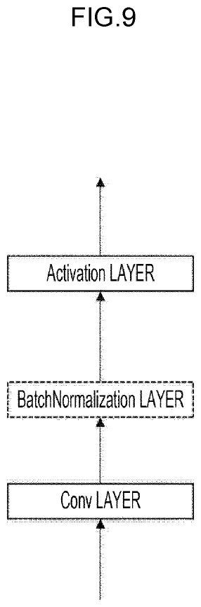

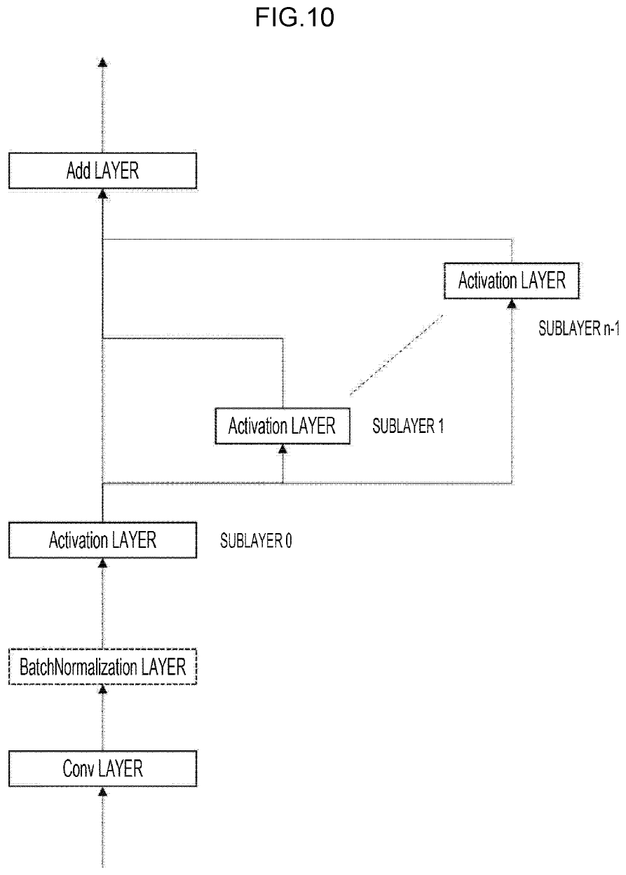

FIG. 9 is a diagram illustrating a part of a layer structure of a series of neural networks with activation function processing. On the other hand, in the present embodiment, the network structure of FIG. 9 is modified as illustrated in FIG. 10.

FIG. 10 is a diagram illustrating an example of the modified network structure.

The network structure illustrated in FIG. 10 is a structure in which the Activation layer is divided into a plurality of layers and an Add layer that combines results of a plurality of layers of the Activation layer into one is added.

That is, as the processing according to the present embodiment, in order to satisfy the true number of pieces, the Activation layer is increased by the minimum number of times of updating the approximation coefficient of the processing LUT with respect to the number of pieces in implementation. Then, in each Activation layer, the activation function processing is performed on only the input value corresponding to one LUT piece, and conversely, zero (0) is output for an input value not corresponding thereto. Then, the results in all the sublayers are finally summed in the Add layer, such that the activation function processing corresponding to the true number of pieces is performed. The Add layer generally receives a plurality of layers as inputs and performs processing of adding feature map values of the same channel and the same position. In the present embodiment, in each sublayer, processing is performed on only the input corresponding to respective LUT pieces, and thus it is possible to implement processing corresponding to the true number of pieces by integrating the results of all sublayers. Here, according to the example of FIG. 10, it means that the activation function processing on an LUT piece 0 in a sublayer 0, an LUT piece 1 in a sublayer 1, and an LUT section n−1 in a sublayer n−1 is performed.

According to the present embodiment, the unit of the control of the operation processing is the unit of the layer, and it is not necessary to perform the LUT update processing according to the update timing of the tile and block. Therefore, the control for the activation function processing circuit can be simplified.

In each embodiment described above, the data processing may be executed by one of various processors such as FPGA or ASIC, or may be executed by a combination of two or more processors of the same or different types (for example, a plurality of FPGAs and a combination of a central processing unit (CPU) and the FPGA). Furthermore, a hardware structure of these various processors is, more specifically, an electric circuit in which circuit elements such as semiconductor elements are combined.

Hereinafter, the data processing device according to each embodiment described above has been described as the example. The embodiment may be in the form of a data processing program for causing a computer to execute the function of the processing unit included in the data processing device. The embodiment may be in the form of a non-transitory computer-readable storage medium storing the data processing program.

All documents, patent applications, and technical standards described in this specification are incorporated herein by reference to the same extent as in a case where a case where incorporation by reference of each document, patent application, and technical standard is specifically and individually described.

Regarding the above-described embodiments, the following Supplementary notes are further disclosed.

### Supplementary Note 1

A data processing device including:
a processor that processes an n-th order polynomial with polynomial approximation for each piece with respect to an input;
a look-up table configured to hold an approximation coefficient used for a polynomial approximation operation; and
a memory that stores approximation coefficients of all pieces when the polynomial approximation is performed, a number of approximation coefficients being larger than a number of table stages of the look-up table,
in which the processor
   selects an input value included in an input domain of the look-up table from among a plurality of input values that are values of the inputs,
   selects only an approximation coefficient of a piece necessary for the operation from the memory,
   stores the selected approximation coefficient in the look-up table,
   outputs, from the look-up table, an approximation coefficient corresponding to the selected input value, and
   performs the polynomial approximation operation by using the selected input value and the output approximation coefficient.

### Supplementary Note 2

A non-transitory storage medium storing a data processing program of a data processing device including
a processor that processes an n-th order polynomial with polynomial approximation for each piece with respect to an input,
a look-up table configured to hold an approximation coefficient used for a polynomial approximation operation, and
a memory that stores approximation coefficients of all pieces when the polynomial approximation is performed, a number of approximation coefficients being larger than a number of table stages of the look-up table,
the data processing program causing a computer to execute processing of:
selecting an input value included in an input domain of the look-up table from among a plurality of input values that are values of the inputs;
selecting only an approximation coefficient of a piece necessary for the operation from the memory;
storing the selected approximation coefficient in the look-up table;
outputting, from the look-up table, an approximation coefficient corresponding to the selected input value; and
performing the polynomial approximation operation by using the selected input value and the output approximation coefficient.

### REFERENCE SIGNS LIST

10 Data processing device
101 Processing unit
102 Input value selection unit
103 Piece selector
104 Processing coefficient storage unit
105 Operation unit
106 Multiplication unit
107 Bit shift unit
108 Addition unit
109 Total coefficient storage unit
110 Intermediate result holding unit

1. A data processing device comprising:
at least one processor that processes an n-th order polynomial with polynomial approximation for each piece with respect to an input;
a look-up table configured to hold an approximation coefficient used for a polynomial approximation operation; and
a total coefficient storage unit that stores approximation coefficients of all pieces when the polynomial approximation is performed, a number of approximation coefficients being larger than a number of table stages of the look-up table,
wherein the at least one processor is configured to:
select an input value included in an input domain of the look-up table from among a plurality of input values that are values of inputs,
select only an approximation coefficient of a piece necessary for the operation from the total coefficient storage unit,
store the selected approximation coefficient in the look-up table, and output, from the look-up table, an approximation coefficient corresponding to the selected input value, and
perform the polynomial approximation operation by using the selected input value and the output approximation coefficient.

2. The data processing device according to claim 1, further comprising an intermediate result holding unit that holds an unprocessed input value not included in the input domain of the look-up table as an intermediate result of the polynomial approximation operation,
wherein the at least one processor receives the unprocessed input value held by the intermediate result holding unit as an input again.

3. The data processing device according to claim 1, wherein the total coefficient storage unit stores the approximation coefficients of all the pieces in units of the number of table stages of the look-up table, and stores the approximation coefficients of all the pieces by assigning an index to each piece of all the pieces.

4. The data processing device according to claim 1, further comprising an intermediate result holding unit that holds an intermediate result of the polynomial approximation operation,
wherein the at least one processor:
performs the polynomial approximation operation on the input value included in the input domain of the look-up table and performs processing of holding an operation result in the intermediate result holding unit,
performs processing of skipping the polynomial approximation operation on an unprocessed input value not included in the input domain of the look-up table and holding the unprocessed input value in the intermediate result holding unit,
performs processing of updating the look-up table with an approximation coefficient of another piece stored in the total coefficient storage unit in a case in which any processing is performed on all input values,
performs processing of performing the polynomial approximation operation and holding an operation result in the intermediate result holding unit in a case in which the unprocessed input value is included in the input domain of the updated look-up table,
performs processing of skipping the polynomial approximation operation and holding the unprocessed input value in the intermediate result holding unit in a case in which the unprocessed input value is not included in the input domain of the updated lookup look-up table,
repeats similar processing until the approximation coefficients of all pieces stored in the total coefficient storage unit are referred to, and
sets the operation result held in the intermediate result holding unit as a final output when the polynomial approximation operation is completed for all the input values.

5. The data processing device according to claim 1, wherein the at least one processor:
updates the look-up table with an approximation coefficient of another piece stored in the total coefficient storage unit in a case in which the at least one processor processes an input value of each block in a first tile for input data supplied in units of tiles including a plurality of blocks each including a plurality of input values,
does not update the updated look-up table in a case in which the processing proceeds from the first tile to a second tile which is a next tile,
updates the updated look-up table in an order opposite to the first tile in a case in which an input value of each block in the second tile is processed,
does not update the look-up table updated in the order opposite to the first tile in a case in which the processing proceeds from the second tile to a third tile which is a next tile, and
updates the look-up table updated in the order opposite to the first tile in an order opposite to the second tile in a case in which an input value of each block in the third tile is processed.

6. The data processing device according to claim 1, wherein;
in activation function processing of a neural network, the at least one processor generates an activation function processing layer as a sublayer by a number obtained by dividing a piece truly necessary for the polynomial approximation operation by a number of pieces of the look-up table implemented in an activation function processing circuit, and
in each sublayer, the at least one processor:
performs the activation function processing on an input value included in the input domain of the look-up table of the divided piece,
performs processing of outputting zero to an input value not included in the input domain of the look-up table, and
performs the activation function processing with polynomial approximation corresponding to a true number of pieces by integrating last generated output results of a plurality of the sublayers in an addition layer.

7. A data processing method performed by a data processing device including:
at least one processor that processes an n-th order polynomial with polynomial approximation for each piece with respect to an input,
a look-up table configured to hold an approximation coefficient used for a polynomial approximation operation, and
a total coefficient storage unit that stores approximation coefficients of all pieces when the polynomial approximation is performed, a number of approximation coefficients being larger than a number of table stages of the look-up table,
the data processing method comprising, by the at least one processor:
selecting an input value included in an input domain of the look-up table from among a plurality of input values that are values of inputs;
selecting only an approximation coefficient of a piece necessary for the operation from the total coefficient storage unit;
storing the selected approximation coefficient in the look-up table;
outputting, from the look-up table, an approximation coefficient corresponding to the selected input value; and
performing the polynomial approximation operation by using the selected input value and the output approximation coefficient.

8. A non-transitory recording medium storing a data processing program of a data processing device including:
at least one processor that processes an n-th order polynomial with polynomial approximation for each piece with respect to an input,
a look-up table configured to hold an approximation coefficient used for a polynomial approximation operation, and
a total coefficient storage unit that stores approximation coefficients of all pieces when the polynomial approximation is performed, a number of approximation coefficients being larger than a number of table stages of the look-up table,
the data processing program being executable by the at least one processor to perform processing comprising causing a computer to execute processing of, by the at least one processor:
selecting an input value included in an input domain of the look-up table from among a plurality of input values that are values of inputs;
selecting only an approximation coefficient of a piece necessary for the operation from the total coefficient storage unit;
storing the selected approximation coefficient in the look-up table;
outputting, from the look-up table, an approximation coefficient corresponding to the selected input value; and
performing the polynomial approximation operation by using the selected input value and the output approximation coefficient.
